(19) United States
(12) Patent Application Publication
(10) Pub. No.: US 2007/0040846 A1
(43) Pub. Date: Feb. 22, 2007

(54) Method and apparatus of correcting color coordinate and display device including apparatus of correcting color coordinate

(75) Inventor: Seong Hwan Kim, Chilgok-gun (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/504,642

(22) Filed: Aug. 16, 2006

(30) Foreign Application Priority Data
Aug. 17, 2005 (KR) 10-2005-0075393

(51) Int. Cl. G09G 5/02

(52) U.S. Cl. 345/589

(57) ABSTRACT

A method and an apparatus of correcting a color coordinate and a display device including the apparatus are provided. The apparatus includes: a first memory for storing optical characteristic information of a display module; a controller for reading the optical characteristic information from the first memory and generating and outputting a color coordinate correction value that corresponds to the read optical characteristic information such that a color coordinate is corrected according to the optical characteristic information; and an interface for transmitting and receiving signals between the first memory and the controller.

### BACKGROUND OF THE INVENTION

1. Field of the Invention

The present invention relates to a method and an apparatus of correcting a color coordinate, and a display device including the apparatus, and more particularly, to a method and an apparatus of correcting a color coordinate using a memory that stores optical characteristic information of a display module, and a display device including the apparatus.

2. Description of the Related Art

With development of technology, various kinds of display modules are mounted on display devices. A manufacturer of a display module is usually different from that of a display device. Accordingly, the manufacturer of the display device is required to re-measure optical characteristic of the display module during manufacturing, and then a procedure of correcting a color coordinate is performed according to the measured optical characteristic.

Configuration of a related art display device is described with reference to FIG. 1.

The display device 10 includes a controller 100, a display driving unit 102, and a display module 114. An example of the display module 114 is an LCD module.

The controller 100 controls each unit of the display device 10.

The display driving unit 102 includes a pre-amplifier 104 amplifying a received gray scale data RGB, an AD converter 106 receiving the amplified data signal RGB and converting the signal RGB into digital signals, a signal processor 108 receiving the converted data signal RGB from the AD converter 106 and performing a signal processing operation according to the controller 100, and a low voltage differential signaling (LVDS) transmission unit 110 receiving the outputted data signal RGB, a clock, and a synchronization signal Dclk/H/V/DE from the signal processor 108 and transmitting the signals into the display module 114 according to the LVDS method.

Additionally, the display driving unit 102 further includes a clock generator 112 supplying the clock Clk synchronized with a horizontal synchronization signal H and the horizontal synchronization signal H into each unit of the display driving unit 102. The display module 114 receives the video data signal from the LVDS transmission unit 110 and displays the signal on a screen.

The related art display device supplies only the video signal into the display module to output. Thus, respectively different optical characteristic information of the display modules can not be obtained. To obtain respectively different optical characteristic information, an additional process of measuring each optical characteristic of the display modules is required.

Although the manufacturer of the display module measures respectively different optical characteristic of the display modules, the manufacturer of the display device may be unaware of the result of the optical characteristic measurement. Therefore, optical characteristic of the display modules is required to be re-measured, and then a procedure of correcting a color coordinate is performed.

### SUMMARY OF THE INVENTION

Accordingly, the present invention is directed to a method and an apparatus of correcting a color coordinate, and a display device including the apparatus that substantially obviate one or more problems due to limitations and disadvantages of the related art.

An object of the present invention is to provide a method and an apparatus of correcting a color coordinate by removing a process of re-measuring optical characteristic information of a display module, and a display device including the apparatus.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an apparatus for correcting a color coordinate, the apparatus including: a first memory for storing optical characteristic information of a display module; a controller for reading the optical characteristic information from the first memory and generating and outputting a color coordinate correction value that corresponds to the read optical characteristic information such that a color coordinate is corrected according to the optical characteristic information; and an interface for transmitting signals between the first memory and the controller.

The first memory may be located in the display module.

The optical characteristic information may be a color coordinate value of the display module at a predetermined color temperature.

The apparatus further may include a second memory for storing a color coordinate correction table where color coordinate correction values corresponding to the optical characteristic information are arranged. The controller may read a color coordinate correction value corresponding to the read optical characteristic information from the color coordinate correction table.

Additionally, color coordinate correction values for each color temperature according to the optical characteristic information may be arranged on the color coordinate correction table. The controller may read and output the color coordinate correction values for each color temperature corresponding to the read optical characteristic information such that a color coordinate is corrected for each color temperature according to the read optical characteristic information.

The controller may control such that a color coordinate of gray scale data transmitted to the display module is corrected according to the output color coordinate correction values.

In another aspect of the present invention, there is provided a method for correcting a color coordinate, the method including: storing optical characteristic information of a display module; reading the optical characteristic information stored in the display module; generating a color coordinate correction value corresponding to the read optical characteristic information; and correcting the color coordinate of a gray scale data transmitted to the display module in response to the color coordinate correction value.

In a further another aspect of the present invention, there is provided a display device including: a display module having a first memory for storing optical characteristic information of a panel; a display driving unit for receiving gray scale data, analog/digital converting the gray scale data, processing the converted data signal and transmitting the gray scale data to the display module; and a controller for reading the optical characteristic information from the first memory and generating and outputting a color coordinate correction value that corresponds to the read optical characteristic information such that a color coordinate is corrected according to the optical characteristic information.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of configuration of a related art display device;

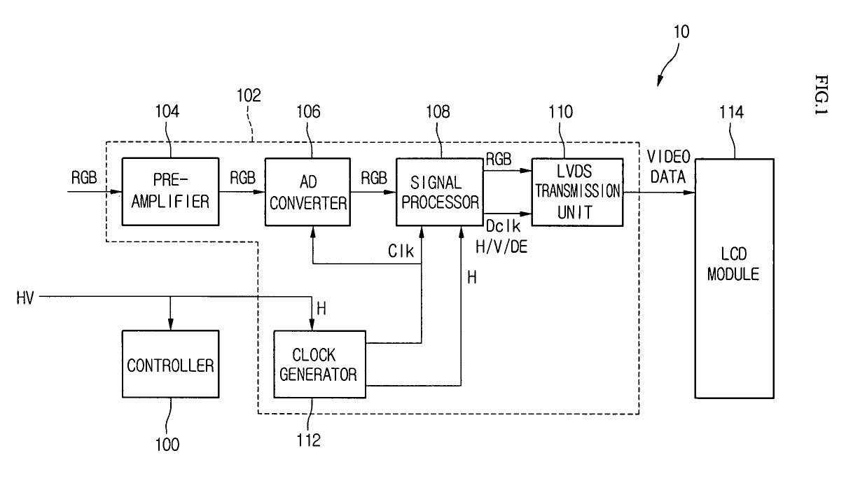

FIG. 2 is a block diagram of configuration of a display device according to an embodiment of the present invention;

FIG. 3 is a flowchart of a method of storing optical characteristic information of a display module;

FIG. 4 is a flowchart of a method of correcting a color coordinate of a display module;

FIG. 5 is a color coordinate correction table; and

FIG. 6 is a graph of color coordinate characteristic in a display module.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

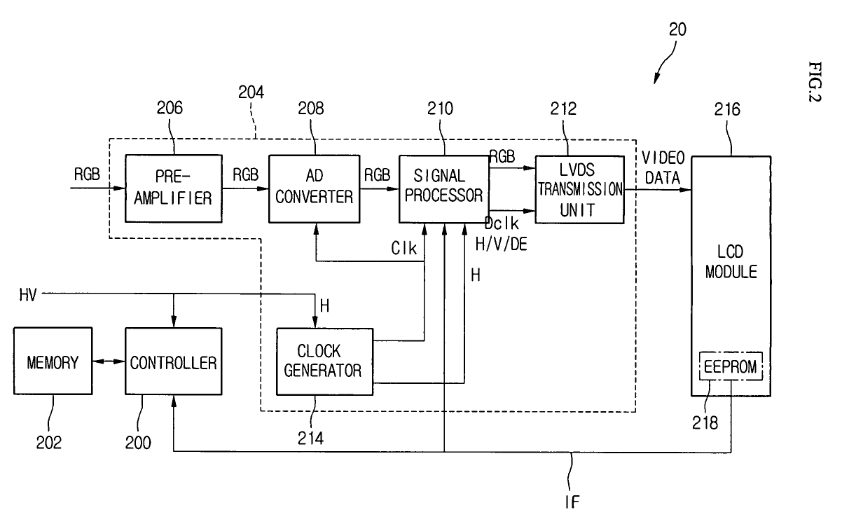

Configuration of a display device is described with reference to FIG. 2.

The display device 20 includes a controller 200, a display driving unit 204, and a display module 216. An example of the display driving unit 204 is an LCD module. The display driving unit 204 includes a pre-amplifier 204 amplifying a received gray scale data RGB, an AD converter 208 receiving the amplified data signal RGB and converting the signal RGB into digital signals, a signal processor 210 receiving the converted data signal RGB from the AD converter 208 and performing a signal processing operation according to the controller 200, and a low voltage differential signaling (LVDS) transmission unit 212 receiving the outputted data signal RGB, a clock, and a synchronization signal Dclk/H/V/DE from the signal processor 210 and transmitting the signals into the display module 216 according to the LVDS method.

Additionally, the display device 20 includes a color coordinate correction device. The color coordinate correction device includes a first memory 218, a controller 200, and an interface IF. The interface IF is connected between the controller 200 and the first memory 218, and is used as a signal transmitting and receiving path between the controller 200 and the first memory 218. In the FIG. 2, an example of the first memory 218 is an EEPROM.

Moreover, the color coordinate correction device further includes a second memory 202. The controller 200 read a color coordinate correction value from the second memory 202. The color coordinate correction value corresponds to optical characteristic information that is read from the first memory 218.

The second memory 202 stores a correction table having color coordinate correction values corresponding to the optical characteristic information. Moreover, the correction table includes arranged color coordinate correction values for each color temperature according to the optical characteristic information. According to the optical character information, a color coordinate can be corrected for each color temperature.

The controller 200 controls the display device 20. When the controller 200 is connected to the display driving unit 204 and the display module 216, it read optical characteristic information stored in the first memory 218 of the display module 216. Moreover, the controller 200 reads the color coordinate correction value for each color temperature from the color coordinate correction table in the second memory 202 according to the optical characteristic information read from the first memory 218. Additionally, the controller 200 control the signal processor 210 in the display driving unit 204 to correct a color coordinate for each color temperature according to the read color coordinate correction value. To communicate with the controller 200 and the first memory 218 of the display module 216, the controller 200 and the first memory 218 can be connected to each other through the interface IF. IIC can be employed as the interface IF.

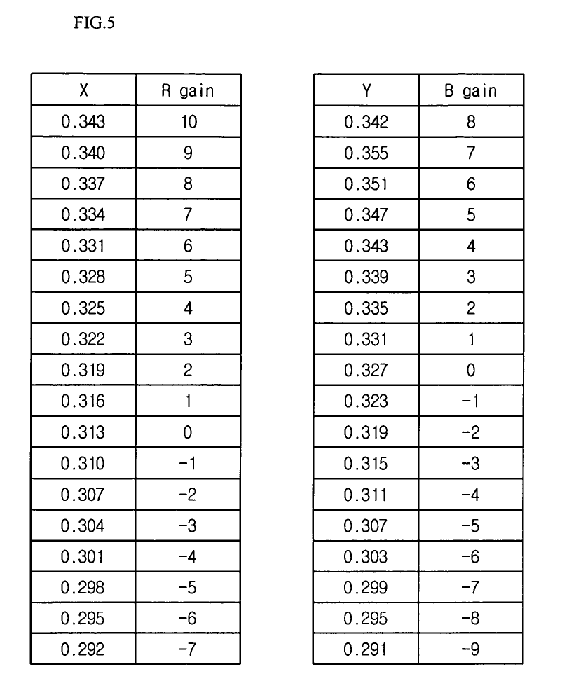

The second memory 202 stores various information with a processing program of the controller 200, and also a color coordinate correction table having color coordinate correction values for each color temperature according to optical character information of the display module 216. As illustrated in FIG. 5, R and B gain values, which are the color coordinate correction values corresponding to optical characteristic information, are mapped and stored in the color coordinate correction table. Referring to FIG. 5, the color coordinate correction value for only one color temperature is illustrated, but color coordinate correction values for a plurality of color temperatures can be mapped and stored.

The signal processor 210 in the display driving unit 204 receives a data signal RGB from the AD converter 208, and performs a signal processing operation such as scaling on the received signal. The controller 200 controls operations of the signal processor 210, and also corrects the color coordinate by controlling gain value of the data signal according to the color coordinate correction value read from the second memory 202.

The display module 216 displays an image according to video data supplied from the LVDS transmission unit 212. As stated above, the display module 216 may include first memory 218 storing optical characteristic information of the display module 216 that is measured during manufacturing.

A method of correcting a color coordinate, which can be applied to the display device, will be described.

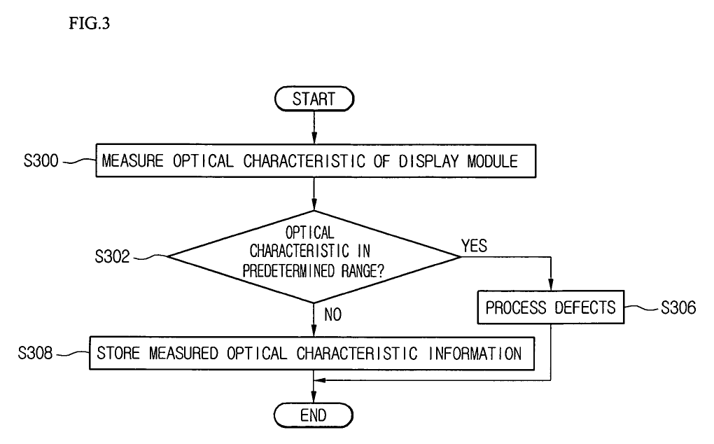

Processes that store optical characteristic information during manufacturing the display module 216 will be described with reference to FIG. 3.

In operation S300, a manufacture of the display module 216 measures optical characteristic to test operations of the display module 216 when shipping the display module 216.

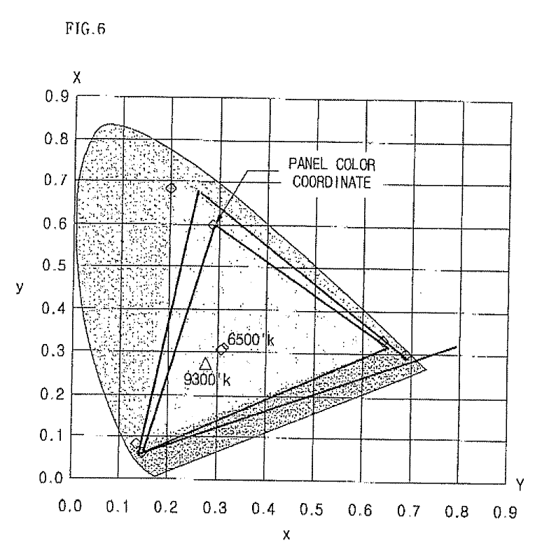

As illustrated in FIG. 6, the optical characteristic measures a color coordinate with reference to the color temperature of 6500° k. The display module 216 is normal when an X value is in a range of 0.313±0.03 and a Y value is in a range of 0.329±0.03 at a color temperature of 6500° k.

In operation S302, when optical characteristic of the display module 216 is measured, the manufacturer determines whether the optical characteristic of the display module 216 is in a predetermined normal range or not.

In operation S304, when the optical characteristic of the display module 216 is out of a predetermined range, the display module 216 is processed as the defective.

Unlike this, when the optical characteristic of the display module 216 is in a predetermined range, the manufacturer stores the measured optical characteristic in the first memory 218 of the display module 216.

The flowchart of FIG. 3 is performed by the manufacturer. It is apparent to those skilled in the art that the optical characteristic information that is related to the display module with a program processing ability like a micro processor is automatically stored.

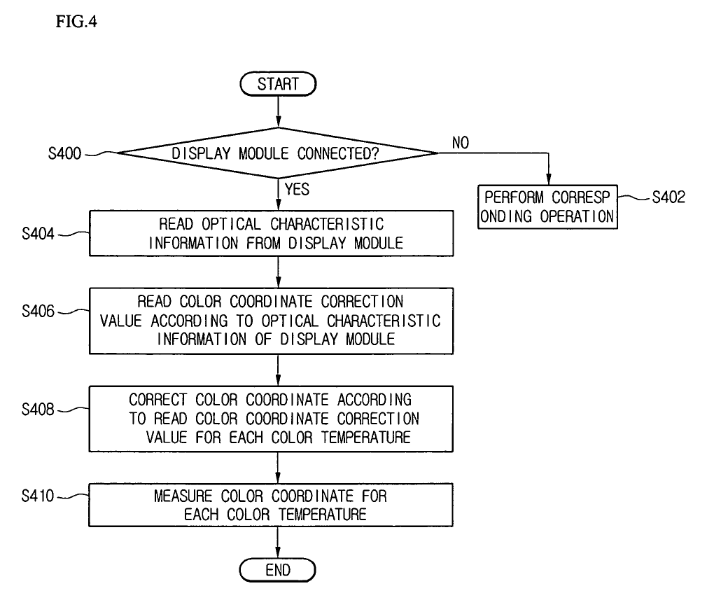

A method of correcting a color coordinate in the display device 20 with the display module 216 that stores the optical characteristic information will be described with reference to FIG. 4.

In operation S400, the controller 200 of the display device determines whether the display module 216 is connected or not. The connection of the display module 216 is determined on the bases of the connections of the controller 200 and the display module 216, and the LVDS receiver and the display module 216.

When the display module 216 is mounted on the display device, the controller 200 reads optical characteristic information stored in the first memory 218 of the display module 216 in operation S404.

In operation S406, when the optical characteristic information of the display module 216 is read, color coordinate correction values corresponding to the optical characteristic information for each color temperature are read from the color coordinate correction table of the second memory 202.

When the color coordinate correction values corresponding to the optical characteristic information are read, the controller 200 controls the signal processors 210 compensating a color coordinate for each color temperature according to the color coordinate correction values. In operation S408, the signal processor 210 corrects and outputs a color coordinate of a video data signal inputted by the controller 200 according to the color coordinate correction value.

When the color coordinate correction is completed, the controller 200 measures a color coordinate for each color temperature after correction such that the manufacturer of the display device 20 confirms that a color coordinate correction for the display module 216 is successful in operation S410.

According to the present invention, the optical characteristic information measured during manufacturing the display module is stored in the memory in the display module, and also the display device corrects a color coordinate according to the stored optical characteristic information. Therefore, the color coordinate correction appropriate for the display module can be performed during manufacturing the display device without measuring the optical characteristic of the display module.

The present invention includes a readable medium. The readable medium stores program commands that are operable in various computers. The computer-readable medium can store program commands, data files, and data structures, or combining those. The program command of the medium is specially designed and configured, or is notified to those skilled in the art for use. The computer-readable recording medium includes a magnetic media (such as a hard disk, a floppy disk, and magnetic tape), an optical media (such as CD-ROM and DVD), a magneto-optical media (such as floptical disk), and also ROM, RAM, and flash memory. Moreover, the computer-readable recording medium includes a hardware device for storing and performing the program commands. The medium can be a transmission medium such as light, metal line, and a waveguide pipe including carrier that transmits a signal indicating program commands and data structures. The program commands can be a machine language code by a compiler and a high-level programming language code by an interpreter, which can be executable in the computer.

According to the present invention, the color coordinate correction appropriate for the display module can be performed during manufacturing the display device without measuring the optical characteristic of the display module.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for correcting a color coordinate, the apparatus comprising:
a first memory for storing optical characteristic information of a display module;
a controller for reading the optical characteristic information from the first memory and generating and outputting a color coordinate correction value that corresponds to the read optical characteristic information such that a color coordinate is corrected according to the optical characteristic information; and
an interface for transmitting signals between the first memory and the controller.

2. The apparatus according to claim 1, wherein the first memory is included in the display module.

3. The apparatus according to claim 1, wherein the optical characteristic information is a color coordinate value of the display module at a predetermined color temperature.

4. The apparatus according to claim 1, further comprising a second memory for storing a color coordinate correction table where color coordinate correction values corresponding to the optical characteristic information are arranged,
wherein the controller reads a color coordinate correction value corresponding to the read optical characteristic information from the color coordinate correction table.

5. The apparatus according to claim 4, wherein color coordinate correction values for each color temperature according to the optical characteristic information are arranged on the color coordinate correction table; and
the controller reads and outputs the color coordinate correction values for each color temperature corresponding to the read optical characteristic information such that a color coordinate is corrected for each color temperature according to the read optical characteristic information.

6. The apparatus according to claim 1, wherein the controller controls such that the color coordinate of gray scale data transmitted to the display module is corrected according to the color coordinate correction values.

7. A method for correcting a color coordinate, the method comprising:
storing optical characteristic information of a display module;
reading the optical characteristic information stored in the display module;
generating a color coordinate correction value corresponding to the read optical characteristic information; and
correcting the color coordinate of a gray scale data transmitted to the display module in response to the color coordinate correction value.

8. The method according to claim 7, wherein the optical characteristic information is stored in a memory included in the display module.

9. The method according to claim 7, wherein the optical characteristic information is a color coordinate value of the display module at a predetermined color temperature.

10. The method according to claim 7, further comprising storing a color coordinate correction table where color coordinate correction values corresponding to the optical characteristic information are arranged,
wherein the generating of the color coordinate correction value comprises reading a color coordinate correction value corresponding to the read optical characteristic information from the color coordinate correction table.

11. The method according to claim 10, wherein color coordinate correction values for each color temperature according to the optical characteristic information are arranged on the color coordinate correction table; and
the color coordinate correction values for each color temperature corresponding to the read optical characteristic information are read such that a color coordinate is corrected for each color temperature according to the read optical characteristic information.

12. A display device comprising:
a display module having a first memory for storing optical characteristic information of a panel;
a display driving unit for receiving gray scale data, analog/digital converting the gray scale data, processing the converted data signal and transmitting the gray scale data to the display module; and
a controller for reading the optical characteristic information from the first memory and generating and outputting a color coordinate correction value that corresponds to the read optical characteristic information such that a color coordinate is corrected according to the optical characteristic information.

13. The display device according to claim 12, further comprising an interface for transmitting signals between the first memory and the controller.

14. The display device according to claim 12, wherein the optical characteristic information is a color coordinate value of the display module at a predetermined color temperature.

15. The display device according to claim 12, further comprising a second memory for storing a color coordinate correction table where color coordinate values corresponding to the optical characteristic information are arranged,
wherein the controller reads a color coordinate correction value corresponding to the read optical characteristic information from the color coordinate correction table.

16. The display device according to claim 15, wherein color coordinate correction values for each color temperature according to the optical characteristic information are arranged on the color coordinate correction table; and
the controller reads and outputs the color coordinate correction values for each color temperature corresponding to the read optical characteristic information such that a color coordinate is corrected for each color temperature according to the read optical characteristic information.

17. The display device according to claim 12, wherein the display driving unit comprises a converter for receiving the gray scale data and analog/digital-converting the received gray scale data; and a signal processor for receiving the converted gray scale data and processing the received data signal.

18. The display device according to claim 17, wherein the controller outputs the color coordinate correction values to the signal processor, and the signal processor corrects the color coordinate of the gray scale data transmitted to the display module according to the input color coordinate correction values.
